(19) United States
(12) Patent Application Publication
(10) Pub. No.: US 2004/0122141 A1
(43) Pub. Date: Jun. 24, 2004

(54) Composite media for ion processing and a method for making the composite media

(76) Inventors: Terry A. Todd, Aberdeen, ID (US); Nicholas R. Mann, Blackfoot, ID (US); Troy J. Tranter, Idaho Falls, ID (US); Ferdinand Sebesta, Prauge (CZ)

Correspondence Address: Stephen R. Christian, BBWI, PO BOX 1625, IDAHO FALLS, ID, 83415-3899, US

(21) Appl. No.: 10/731,836

(22) Filed: Dec. 8, 2003

Related U.S. Application Data
(63) Continuation-in-part of application No. 10/302,471, filed on Nov. 21, 2002.
Application No. 10/302,471 is a division of application No. 10/039,320, filed on Oct. 19, 2001, now Pat. No. 6,514,566.
(63) Continuation-in-part of application No. 10/021,663, filed on Oct. 23, 2001.
(60) Provisional application No. 60/241,736, filed on Oct. 19, 2000.
(60) Provisional application No. 60/242,623, filed on Oct. 23, 2000.

(51) Int. Cl. B05D 3/02; C08K 5/17

(52) U.S. Cl. 524/236; 427/385.5

(57) ABSTRACT

A composite medium including at least one trialkyl methylammonium compound homogenously dispersed in a polyacrylonitrile matrix. The composite medium may be formed into beads or may be impregnated into a substrate and used in an ion processing element. The at least one trialkyl methylammonium compound may comprise trialkyl methylammonium nitrate or trialkyl methylammonium chloride and may be present from approximately 5% by weight to approximately 30% by weight. The polyacrylonitrile may be present in the composite medium from approximately 70% by weight to approximately 95% by weight. A method of forming the composite medium is also disclosed, as is a method of removing a constituent from a fluid stream.

### CROSS-REFERENCE TO RELATED APPLICATIONS

This application is a continuation-in-part of U.S. patent application Ser. No. 10/302,471, filed on Nov. 21, 2002, which is a divisional of U.S. patent application Ser. No. 10/039,320, filed on Oct. 19, 2001 and issued as U.S. Pat. No. 6,514,566 on Feb. 4, 2003, which claims the benefit of U.S. patent application Ser. No. 60/241,736, filed on Oct. 19, 2000, and which are hereby incorporated by reference. This application is also a continuation-in-part of U.S. patent application Ser. No. 10/021,663, filed on Oct. 23, 2001, which claims the benefit of U.S. patent application Ser. No. 60/242,623, filed on Oct. 23, 2000, and which are hereby incorporated by reference.

### GOVERNMENT RIGHTS

The United States Government has rights in the following invention pursuant to Contract No. DE-AC07-991D13727 between the U.S. Department of Energy and Bechtel BWXT Idaho, LLC.

### FIELD OF THE INVENTION

Field of the Invention: The present invention relates generally to the preparation and use of composite media for use in ion processing. More particularly, embodiments of the present invention relate to the preparation and use of ion processing elements that include composite media dispersed in a porous substrate.

### BACKGROUND OF THE INVENTION

Effective and efficient ion processing is one consideration in numerous chemical and industrial processes. In general, ion processing refers to those processes, and/or devices that implement such processes and that are used to facilitate neutralization, removal, concentration, or other processing of one or more ions present in a fluid stream, examples of which include industrial waste and process streams. One example of such a process involves the removal of materials such as cesium, strontium, and/or uranium from an industrial waste stream prior to the discharge of the fluid stream into the environment.

While ion processing components and processes are often employed to remove undesirable constituents of a fluid volume or stream, such components and processes may also be used to collect and concentrate one or more desirable constituents of a fluid volume or stream so that those constituents can then be reserved for future use.

One area where ion processing techniques, materials, and devices are particularly useful is in the industrial environment. Typical industrial waste and process streams present at least two significant challenges to ion processing efforts. The first challenge relates to the flow rates of such industrial waste and process streams. Because industrial waste and process streams are often characterized by relatively high flow rates, the associated ion processing materials, systems, and components should be capable of admitting and processing the high flow rate waste and process streams without introducing an undue pressure drop or other resistance to flow that would tend to compromise the flow rate of those streams and slow down the overall rate at which ion processing occurs.

Another challenge that should be considered when implementing the treatment of industrial waste and process streams relates to the level of cleanliness to be attained in the processed stream. In particular, the streams produced in industrial environments are often required to meet stringent standards with regard to the permissible concentration of various contaminants or other materials that are ultimately discharged into the environment. Thus, the treatment systems and devices should be able to handle relatively high fluid flow rates at a high level of efficiency.

Generally, the effectiveness and efficiency of a particular ion processing material is at least partially a function of the total surface area of an active component that contacts the material or fluid to be processed. The surface area, in turn, is a function of the porosity, or pore volume, of the ion processing material. Typically, relatively more porous ion processing materials possess a relatively greater surface area than relatively less porous ion processing materials. Thus, when considering two ion processing materials equivalent in all other regards, an ion processing material with a relatively larger surface area is capable of removing a relatively greater amount of contaminants or impurities from the fluid stream than an ion processing material with a relatively smaller surface area. In light of this relationship, a number of ion processing materials, systems, and devices have been devised to provide a relative increase in the surface area of the ion processing material to improve its effectiveness.

Various methods have been used to prepare ion processing materials to provide a relative increase in the surface area of the active component of the ion processing material that comes into contact with the fluid stream to be processed. In one case, the ion processing material is a composite medium that generally includes a supporting matrix and one or more active components dispersed within the matrix. Typically, the matrix comprises a plurality of small, slightly porous particles, sometimes referred to as beads. As suggested above, the overall surface area of the ion processing material that contacts the fluid stream comprises the sum of the surface areas of each of the individual beads, which, in turn, is a function of pore volume. One such product, TEVA® resin, is commercially available from Eichrom Technologies Inc. (Darien, Ill.) and uses an aliphatic quaternary amine as the active component that is absorbed into pores of the matrix. TEVA® resin is produced by first treating a solid, porous substrate material, such as Amberlite XAD-7, to remove all preservatives. A known weight of the substrate material is then slurried in methanol that contains trialkyl methylammonium nitrate diluted with dodecane. The slurry is stirred for several minutes under vacuum at 40° C., leaving a liquid trialkyl methylammonium nitrate/docecane mixture dispersed in the pores of the substrate material. Other products, such as TEVA® disc resin or TEVA® disc, are also commercially available from Eichrom Technologies Inc. These products include the aliphatic quaternary amine and the nonionic acrylic ester polymer incorporated in a substrate.

In order to form the ion processing material, the matrix material is mixed with a particular active component selected for its ability to remove one or more pre-determined constituents from the fluid stream. The active component permeates into pores of the matrix and absorbs to the matrix material. The ion processing material thus produced is typically disposed in a column through which the fluid stream to be processed is passed. Because the beads of the matrix material often assume a somewhat spherical shape, a plurality of spaces are cooperatively defined by adjacent beads. Accordingly, the fluid stream is able to flow through the ion processing material by working its way through the spaces between the individual beads.

While the slight porosity of some beads allows for a relatively greater ion processing area than would be possible if the beads were simply solid, such matrix materials have, as a result of their relatively small pore volume, proven rather ineffective in providing the performance required for effective and efficient processing of high volume fluid streams. Since the pore volume is small, only a limited portion of the active component permeates into the pores and absorbs to the matrix. For instance, in the TEVA® products previously discussed, the sorption capacity and kinetics are limited because the pore volume of the matrix is small. Therefore, only a small amount of the aliphatic quaternary amine is sorbed into the pores of the matrix. In addition, the TEVA® products have a low percentage of the active component and, therefore, have a low ion processing capacity.

Of course, the surface area of such ion processing materials can be increased somewhat by increasing the number of beads present in a particular column. However, there are practical limits to the attainment of very small bead sizes. Furthermore, while an increase in the number of beads produces a desirable overall increase in pore volume, and thus ion processing area, the increase represents a tradeoff with respect to the flow rate that a particular ion processing material can effectively accommodate.

In particular, as bead size is reduced, the size of the air spaces between adjacent beads is correspondingly reduced. Reduction in the size of the air spaces has at least one unfavorable consequence with respect to the flow of the fluid stream. Specifically, assuming a constant flow velocity, the volume of fluid that can flow through an opening is primarily a function of the size or area of that opening. This idea is generally expressed in the relationship Q=Va, where “Q” is the volume of fluid flow per unit of time, “V” is the velocity of the fluid, and “a” is the area through which the fluid passes.

In general then, where two volumes of ion processing materials in the form of respective composite media, equal in all other respects, have different numbers of beads, the volume of the ion processing material with relatively more beads defines a relatively smaller space through which the process stream can flow. In view of the aforementioned flow relationship, this means that the volume of ion processing material with a relatively greater number of beads is relatively more resistant to the flow of the process stream. Accordingly, in the case of an ion processing material comprised of very small particles, a powdered ion processing material for example, the resistance of the ion processing material to fluid flow is significant.

Thus, in the case of ion processing materials comprised of a composite medium employing a bead type matrix, the surface area of the ion processing material can be readily increased by increasing the number of beads. However, due to the inverse relationship, discussed above, between the air volume defined by the ion processing material and the ability of a given volume of the ion processing material to pass a predetermined flow, there are practical limits to the extent to which the surface area may usefully be increased.

As suggested earlier, another common ion processing material configuration is designed along the same general principles as those ion processing materials formed as composite media, but takes on a somewhat different form. In this particular configuration, no matrix is employed. Rather, a finely granulated or powdered active component is simply compressed under high pressure to form an ion processing material comprising a plurality of granules, or pellets, which are then disposed in a column for processing of a fluid stream.

While ion processing materials using compressed active component configurations typically have relatively large surface areas, they suffer from a variety of significant shortcomings. First, because the active component is initially in a powdered form, the flow of the fluid through a bed of granules of the active component of the ion processing material tends to wash away some of the active component, thus reducing the effectiveness and efficiency of the ion processing material over time. Another problem is that granules or pellets of the compressed active component tend to be rather brittle and can be easily broken and thereby rendered ineffective. Further, ion processing materials formed in this manner tend to crumble and fall apart over a period of time. Such ion processing material configurations are not well suited to withstand the rough handling and other conditions that may occur in many industrial environments.

Yet another shortcoming of compressed active component ion processing materials concerns the compression process that is used to form the granules or pellets of the compressed active component. In particular, large compressive forces are typically employed in order to ensure that the active component granules assume and retain the desired shape and size. However, the forces used to form the active component granules compress the active component so tightly that it is often the case that the fluid flow being processed never penetrates to the active component at the inner portion of the granules. Thus, the ion processing capacity of the active component in these types of ion processing materials is not fully utilized and much of the active component is wasted. Such waste unnecessarily increases the amount, and thus the cost, of the ion processing material.

An additional configuration of the ion processing material includes incorporating the ion processing material into discs or membranes made of a fibrous material, such as of a glass wool fiber.

While the aforementioned shortcomings are of some concern in low volume ion processing applications, such as might be encountered in a laboratory, these characteristics of ion processing materials that comprise compressed active component granules render such ion processing materials particularly unsuited for high volume applications, such as are typically encountered in industrial environments.

In industrial environmental applications, for example, it is often the case that large volumes of fluid, in some cases as much as 100 to 400 gallons, must be sampled so that analyses of the sample will provide accurate and scientifically valid results. Types of fluids typically sampled include, but are not limited to, ocean water, groundwater, water from inland waterways such as lakes and rivers, landfill runoff, and the like.

In addition, environmental sampling of some samples, such as to detect low level radioactive contamination of uranium, plutonium, americium, cesium, strontium, and technetium, is currently difficult due to the low activities of these materials. Therefore, large volumes of samples containing these contaminants are concentrated by one or two orders of magnitude or a liquid-liquid solvent extraction technique is used to concentrate the activities of the sample. Concentration is required to achieve the necessary detection limits established for screening these environmental samples. However, in order to concentrate these samples, the large sample volumes are collected and transported to the laboratory for concentration and analysis.

Because of the inability of known ion processing media, devices, and systems to readily process large volumes of fluids, personnel sampling these fluids are often compelled to collect the sample required and transport the sample back to a processing facility for analysis. Transportation of such large samples can be problematic in many cases, especially where the sample is gathered in a location remote from the laboratory or facility where the sample is to be analyzed. In particular, transportation of large samples from remote locations is both time-consuming and expensive.

A related problem concerns processing of large samples once they finally reach the processing facility. Typically, such samples must be evaporated and/or otherwise treated by processes comprising numerous steps so that the constituents of those samples can be concentrated before they are analyzed. Such extensive processing is undesirable, at least in part because it is time-consuming, expensive, and often requires special equipment.

In view of the foregoing problems and shortcomings with existing ion processing materials and systems, it would be an advancement in the art to provide an ion processing element comprising a large surface area composite medium disposed in a porous substrate which offers relatively little resistance to fluid flow. The ion processing element is useful in high volume applications that require the effective and efficient removal, or other processing, of compounds, such as actinides or lanthanides.

### BRIEF SUMMARY OF THE INVENTION

The present invention relates to a composite medium comprising at least one trialkyl methylammonium compound homogenously dispersed in a polyacrylonitrile matrix. The composite medium may be impregnated into a substrate and used in an ion processing element. The at least one trialkyl methylammonium compound may comprise at least one of trialkyl methylammonium nitrate or trialkyl methylammonium chloride and may be present from approximately 5% by weight to approximately 30% by weight. The polyacrylonitrile may be present in the composite medium from approximately 70% by weight to approximately 95% by weight.

The present invention also relates to a method of forming a composite medium. The method comprises dissolving polyacrylonitrile in a solvent to form a matrix solution. At least one trialkyl methylammonium compound may be combined with the matrix solution to form a homogenous, composite medium solution. The solvent may then be diluted so that the homogenous, composite medium solution solidifies, entrapping the at least one trialkyl methylammonium compound in the polyacrylonitrile. The solvent may be diluted by depositing portions of the composite medium solution into a water bath. The portions of the composite medium solution, once solidified, may form homogenous, substantially spherical beads.

Alternatively, the homogenous, composite medium solution may be impregnated into a substrate. The solvent may then be diluted by depositing the substrate into a water bath.

In addition, the present invention relates to a method of removing a constituent from a fluid stream. The method comprises providing a composite medium comprising at least one trialkyl methylammonium compound homogenously dispersed in a polyacrylonitrile matrix. The fluid stream comprising the constituent may be passed through the composite medium to remove the constituent from the fluid stream. The fluid stream may comprise plutonium and americium. By passing the fluid stream through the composite medium, plutonium may be selectively removed from the fluid stream over americium. Alternatively, the fluid stream may comprise technetium, which may be removed by passing the fluid stream through the composite medium.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1 illustrates various features of an embodiment of an ion processing system;

FIG. 2 illustrates various features of an embodiment of an ion processing assembly for use in an ion processing system;

FIG. 3 is a negative image depiction of an embodiment of a composite medium;

FIG. 4 indicates one embodiment of a process for making an ion processing element configured as a filter disk impregnated with PAN and Aliquat 336; and

FIG. 5 indicates another embodiment of a process for making an ion processing element configured as beads impregnated with PAN and Aliquat 336.

### DETAILED DESCRIPTION OF THE INVENTION

A composite medium useful in high volume applications that require the effective and efficient removal, or other processing, of compounds, such as actinides or lanthanides, may be produced. The composite medium may include a large surface area matrix material within which at least one active component is disposed. The composite medium may be used as a solid extractant, such as beads, or disposed in a porous substrate and incorporated into an ion processing element.

The solid extractant or ion processing element may be used to remove components or constituents of a fluid stream. As used herein, the term “fluid stream” includes streams having both gaseous and liquid components, as well as streams that are in substantially liquid form or streams that substantially comprise one or more gaseous components. For instance, the ion processing element may be used in high volume applications that require the effective and efficient removal of actinides such as uranium (U), plutonium (Pu), and americium (Am); lanthanides such as europium (Eu) and cerium (Ce); alkali metals such as cesium (Cs); alkaline earth metals such as strontium (Sr); transition metals such as technetium (Tc); organic contaminants; or chlorine (Cl) from the fluid stream. As used herein, the term “actinide” refers to an element of the Actinide Series as depicted by the Periodic Chart of the Elements, as well as any and all compounds substantially comprising an element of the Actinide Series. Similarly, the term “lanthanide” refers to an element of the Lanthanide Series as depicted by the Periodic Chart of the Elements, as well as any and all compounds substantially comprising an element of the Lanthanide Series. For instance, the ion processing element may be used to selectively remove Pu over Am in acidic samples or solutions. Additionally, the ion processing element may be used to remove Tc from alkaline, neutral, or slightly acidic solutions.

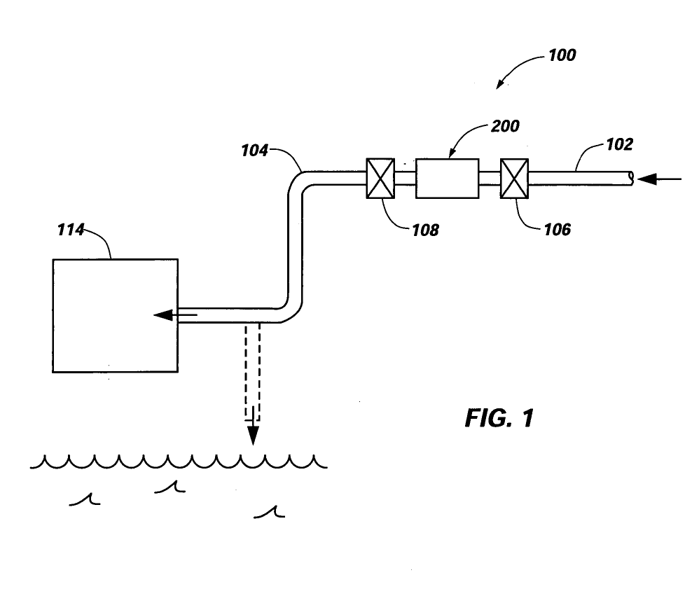

FIGS. 1 through 5 indicate various exemplary embodiments of an ion processing element and related materials, processes, and systems. In FIG. 1, an ion processing system is indicated generally at 100 and the direction of the flow of fluid through ion processing system 100 is indicated by arrows. Ion processing system 100 may include column assembly 200, column inlet piping 102 and column outlet piping 104. Isolation valves 106 may be disposed upstream and downstream of column assembly 200. Ion processing system 100 may also include a reservoir 114 in fluid communication with column outlet piping 104. Additionally, ion processing system 100 may include a variety of other components including, but not limited to, prime movers such as pumps. Various types of diagnostic and/or monitoring instrumentation may also be provided in ion processing system 100 including, but not limited to, devices for measuring temperatures, flow rates, and ion concentration at one or more points throughout ion processing system 100.

In one embodiment, ion processing system 100 may be used in conjunction with the processing of a fluid stream containing one or more actinides such U, Pu, Am, or compounds thereof; one or more lanthanides such as Eu, Ce, or compounds thereof; one or more transitional metals such as Tc or compounds thereof; one or more alkali metals such as Cs or compounds thereof; or alkaline earth metals such as Sr or compounds thereof. The ion processing system 100 may be used to remove elements or constituents from the fluid stream. In addition, the ion processing system 100 may be used to selectively remove one or more elements or constituents over other elements or constituents in the fluid stream. For instance, the ion processing system 100 may be used to selectively remove tetravalent ions over trivalent ions in the fluid stream.

Other embodiments of ion processing system 100 may be used to remove organic contaminants and Cl from fluid streams. The fluid streams may include, but are not limited to, fluid streams generated in industrial water treatment, drinking water treatment, alkaline waste treatment, radioactive waste treatment, and treatment of various types of waste produced, for example, as a result of industrial operations and processes. However, the use of ion processing system 100 is not limited to these exemplary applications. For example, ion processing system 100 may be used with relatively small scale systems and operations such as are typically employed in laboratories and similar facilities.

In operation, the fluid stream to be processed may be directed into ion processing assembly inlet piping 102 and passes through ion processing assembly 200, where one or more constituents are substantially removed. The fluid stream may then be directed to reservoir 114 by way of ion processing assembly outlet piping 104, preparatory to further processing or disposal. Depending upon such variables as the content(s), temperature, and volume of the fluid stream, the fluid stream may alternatively be directed to a waterway or other portion of the environment after processing, as suggested by the phantom lines in FIG. 1. When it is desired to remove ion processing assembly 200, isolation valves 106 can be shut to prevent flow through ion processing assembly inlet piping 102 and ion processing assembly outlet piping 104, and thereby facilitate the removal and/or replacement of ion processing assembly 200.

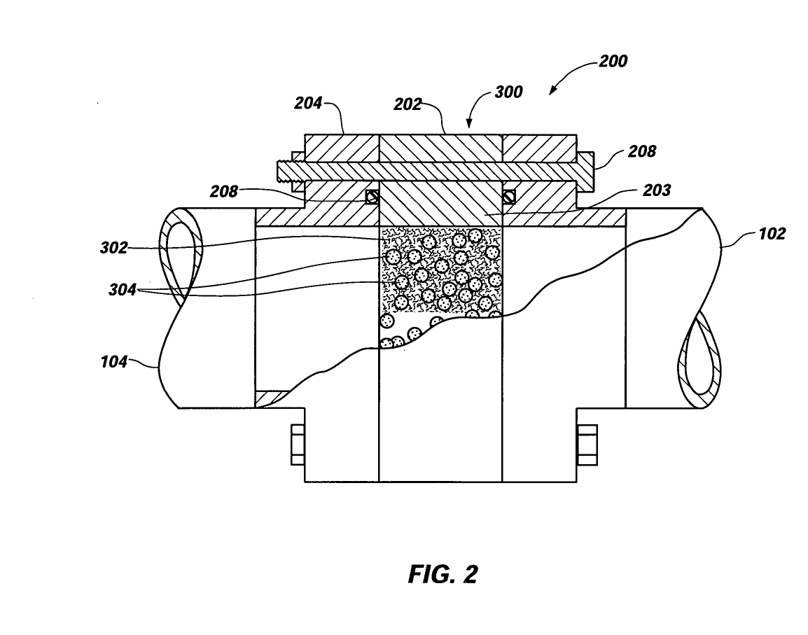

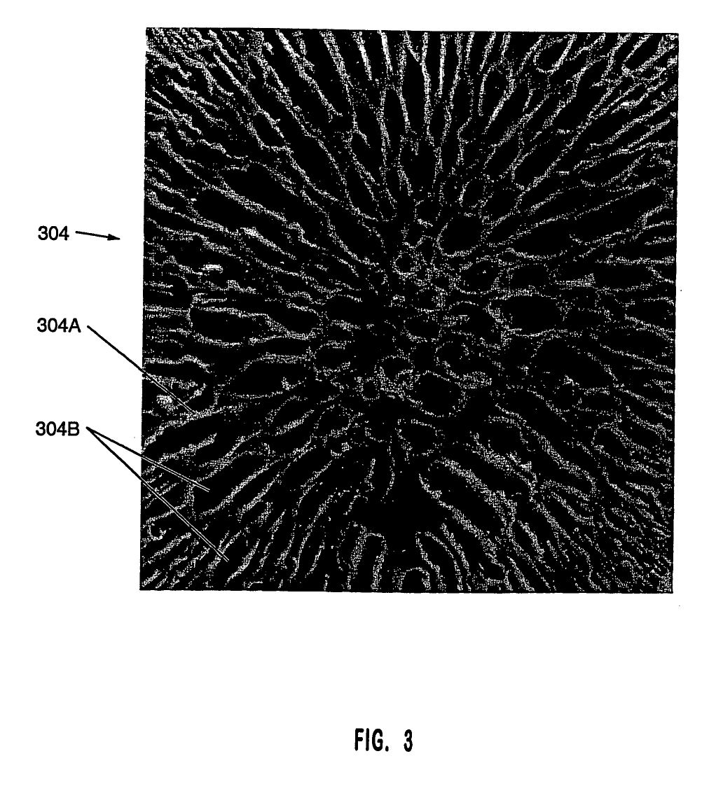

Turning now to FIG. 2, various details and features of an embodiment of ion processing assembly 200 are indicated. In particular, ion processing assembly 200 may include a housing 202 that defines a chamber 203 in which ion processing element 300 is substantially confined. Features such as the geometry and/or dimensions of ion processing element 300 may be varied as required to suit a particular application and/or to facilitate achievement of one or more desired results. Ion processing element 300 may include substrate 302 impregnated with composite medium 304. Composite medium 304, in turn, may include matrix material 304A (see FIG. 3), which defines a plurality of pores 304B (see FIG. 3) that serve to support, i.e., contain, entrap, bond to, or otherwise include, attach, or retain in any way, one or more active components (not shown).

With continuing reference to the details of ion processing assembly 200, housing 202 may be disposed between, and removably retained by, flanges 204. As indicated in FIG. 2, flanges 204 are configured for connection to ion processing assembly inlet piping 102 and ion processing assembly outlet piping 104, respectively, to facilitate fluid communication between ion processing element 300 and ion processing assembly inlet piping 102 and ion processing assembly outlet piping 104. Flanges 204 may also be connected to ion processing assembly inlet piping 102 and ion processing assembly outlet piping 104 in a variety of other ways including, but not limited to, welding, brazing, soldering, threaded connections, or the like. Bolts 206, or the like, may removably secure housing 202 in place between flanges 204. Finally, O-rings 208, or the like, may be interposed between the faces of flanges 204 and housing 202 to substantially prevent leakage of the fluid stream from ion processing assembly 200.

Note that a variety of means may be employed to perform the function of flanges 204, as disclosed herein. Thus, flanges 204 are but one example of a means for removably retaining housing 202. It should accordingly be understood that flanges 204 simply represent one embodiment of structure capable of performing this function and should not be construed as limiting the scope of the present invention in any way. For example, the functionality of flanges 204 could alternatively be achieved with various types of quick-release fittings, twist-lock type fittings, or the like.

Directing continuing attention to FIG. 2, the fluid stream from which one or more constituents are to be removed may enter housing 202 by way of ion processing assembly inlet piping 102. As the fluid stream passes through substrate 302, one or more active component(s) of composite medium 304 may remove one or more constituents from the fluid stream. After passing through ion processing element 300, the fluid flow may exit ion processing assembly 200. Ion processing assembly outlet piping 104 then directs the fluid flow to at least one predetermined location. While ion processing assembly 200 may be oriented in a substantially vertical position, other orientations may alternatively be employed.

With reference now to FIG. 3, additional details are provided regarding the geometry of an exemplary embodiment of composite medium 304 in accordance with the teachings of the present invention. As indicated in FIG. 3, composite medium 304 may include a matrix material 304A that defines a plurality of openings or pores 304B. The pores 304B defined by the matrix material 304A may be large macropores. In addition, small micropores may be present in the matrix material 304A. The active component may be incorporated into the micropores in the matrix material 304A or may be trapped as a solid material in the pores 304B. Due to the large number of pores 304B, composite medium 304 may accordingly define a large surface area available to support one or more active component(s) (not shown).

As previously discussed, the effectiveness of an ion processing medium is at least partially a function of the size of the ion processing surface area with which the processed medium, typically a fluid, comes into contact. Thus, the relatively large surface area collectively defined by pores 304B of composite medium 304 may facilitate a material improvement in processing capacity over known ion processing media and devices in which only a fraction of the active component may come into contact with the fluid stream or where the volume of active component that may be employed is otherwise restricted in some way. That is, due to the large surface area defined by pores 304B of composite medium 304, a relatively greater amount of active component may be exposed to the fluid stream than is typically the case with known composite media.

Because relatively more active component may be exposed to the fluid stream than would otherwise be the case, a given volume of active component, supported by matrix material 304A of composite medium 304, may remove relatively more material from the fluid stream than would a comparable volume of many known ion processing media. In addition, the given volume of active component may remove material from the fluid stream more quickly than a comparable volume of many known ion processing media. That is, composite medium 304 may be relatively more efficient in removing materials from a fluid stream than are known composite media. Accordingly, the composite medium 304 may have a higher processing capacity than those materials.

In some instances at least, the processing capacity of active component may be quantified as being the maximum value of the ratio of the mass of the ion removed from the fluid stream to the mass of active component present in ion processing element 300. In view of the improved processing capacity of composite medium 304, the cost of an ion processing system employing composite medium 304 may be materially lower than the cost of devices employing less efficient ion processing materials.

Not only may the geometry of matrix material 304A of composite medium 304 facilitate an increase in the ion processing capacity of active component to a level materially higher than would otherwise be possible, but that geometry may have other implications as well. One such implication relates to the amount of active component that matrix material 304A can effectively hold. In particular, the large pore volume defined by matrix material 304A of composite medium 304 may permit the weight of active component, as a percentage of the total weight of composite medium 304, to be varied over a wide range, such as from about 5% to about 95% by weight. In contrast, the weight percentage of active component in some known composite media is typically limited to a much narrower range. In one embodiment, the weight of the active component, as a percentage of the total weight of composite medium 304, ranges from about 5% to about 30%.

Thus, composite medium 304 may facilitate wide variations in the concentrations, or loading, of active component. The loading of active component in composite medium 304 may desirably be varied as required to suit particular applications and/or to achieve one or more desired results. Further, multiple active components may be employed in composite medium 304 to produce a composite medium 304 that may be employed to effect simultaneous and substantial removal, or other processing, of more than one constituent of the fluid stream. As noted elsewhere herein, such active components may employ any of a variety of mechanisms to effectuate such removal and/or processing.

Finally, the flow characteristics of ion processing element 300 may be enhanced by the fact that substrate 302 of ion processing element 300 is highly porous. Thus, ion processing element 300 may be used in high flow rate applications, such as those encountered in industrial environments.

As the foregoing discussion suggests, ion processing element 300 may possess a number of properties that make it desirable for use in a wide range of applications, such as those situations where it is desired to effectively and efficiently treat high volume and/or high flow rate fluid streams. By way of example, the relatively large surface area defined by matrix material 304A of composite medium 304 may facilitate high loading capacities and effective and efficient use of active component. As another example, the porosity of substrate 302 may permit fluid to flow readily through ion processing element 300 and, thus, facilitates effective and efficient processing of high flow rate fluid streams.

Attention is directed now to a discussion of various exemplary active components. As used herein, the term “active component” refers to those materials, however embodied, that use a variety of mechanisms to process the fluid stream. These mechanisms may include, but are not limited to, ion exchange, adsorption, absorption, extraction, complexation, or various combinations thereof. By employing one or more of these mechanisms, various embodiments of active components may be able to, among other things, remove, extract, separate, concentrate, or otherwise desirably process one or more constituents of a fluid stream. For instance, the active component may include a sorbent or a similar material.

The at least one active component may include an inorganic compound, such as crystalline silicotitanate (CST) or the like. However, any of a wide variety of other active components, both organic and inorganic, may be used either individually or in various combinations as required to suit a particular application and/or to achieve one or more desired effects. The active component may be a chelating agent, such as an extractant, or an ion exchange sorbent. Exemplary active components may include various types of carbon; ammonium molybdophosphate (AMP); octyl (phenyl) N,N-diisobutylcarbamoylmethylphosphine oxide (CMPO) and other carbamoyl phosphine oxides; 4,4′(5′)di-(t-butylcyclohexano)-18-crown-6, bis (2,4,4-trimethylpentyl) dithiophosphinic acid; various amines; alkylphosphoric acids, such as bis(2-ethylhexyl)phosphoric acid (HDEHP); neutral organophosphorus compounds, such as tributyl phosphate (TBP); organic compounds, such as crown ethers and polyethylene glycol (PEG) and their mixtures; and all organic extractants that are stable in the solution of the binding polymer, such as PAN, and are able to form an organic phase inside the matrix.

Organic active components, such as activated carbon, may be used in the processing of water and are effective in removing, among other things, chlorine, organic pesticides, and heavy metals such as mercury. As used herein, the term “carbon” includes activated carbon as well as various other types and forms of carbon or materials substantially comprising carbon. In addition, active components may be employed in odor control applications, and air cleaning and/or purification, as well as in the removal of undesirable color(s) from a fluid stream, as might be desired in pharmaceutical applications. Additionally, various combinations of active components may be employed in conjunction with a particular volume of ion processing element 300 to facilitate achievement of one or more desired ion processing effects. Also, in some embodiments of the invention, multiple ion processing elements 300, each comprising one or more active components, may be employed in a single ion processing system to facilitate removal of various constituents from a fluid stream.

In one embodiment of the composite medium 304, a quaternary amine, such as Aliquat 336, may be used as the active component. Aliquat 336 is an extractant that selectively removes tetravalent ions over trivalent ions. Aliquat 336 is a trialkyl methylammonium nitrate or a trialkyl methylammonium chloride and has the following structure:

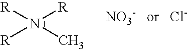

where R=C₈H₁₇ and C₁₀H₂₁. Aliquat 336 is also known as tricaprylylmethylammonium chloride or trioctylmethylammonium chloride and is available from various sources, such as Sigma-Aldrich Co. (St. Louis, Mo.). While the examples herein describe using Aliquat 336 as the active component, it is understood that other structurally-related, quaternary amine compounds may be used to remove constituents from the fluid stream. For instance, derivatives of Aliquat 336, such as compounds having different alkyl groups as the R group, may be used. In addition, Aliquat 336 may be used in combination with other active components to remove constituents from the fluid stream. For instance, Aliquat 336 and a derivative of Aliquat 336 may be used as the active component.

The matrix material may be an organic polymer having a high surface area, such as PAN. As used herein, the term “PAN” includes, among other things, an acrylonitrile polymer or a copolymer containing at least about 40% acrylonitrile units. For instance, the PAN may be an acrylonitrile polymer or a copolymer having a ratio of at least about 40% acrylonitrile molecules to total molecules. PAN may be provided in a solid form. The acrylonitrile homopolymer may include crystalline, quasicrystalline, and/or amorphous phases. In addition to PAN, other polymeric matrix materials, such as organic or inorganic polymers, may be used to meet the requirements of a particular application.

A variety of substrate 302 materials may be used with the composite medium 304 to produce ion processing elements 300 having one or more particular desired properties. In one embodiment, substrate 302 may include fibrous glass or the like. The fibrous nature of substrate 302 renders substrate 302 highly porous and, thus, materially enhances at least the kinetics and exchange capacity and, thus, the overall performance of ion processing element 300. Other substrate 302 materials contemplated as being within the scope of the present invention include, but are not limited to, Teflon™ materials, paper, and the like. For instance, a filter disk made from glass fiber, paper, or polytetrafluoroethylene (Teflon™) and its derivatives may be used as the substrate 302. Substrate 302 materials are known in the art and may include, but are not limited to, those available under the Gelman® or Whatman® tradenames from numerous chemical supply sources, such as Pall Corp. (East Hills, N.Y.). In general however, any other materials or combinations thereof, providing the functionality of fibrous glass, as herein disclosed, are contemplated as being within the scope of the present invention. Note that substrate 302 is not necessarily limited to fibrous materials but may also include substrates 302 comprising any other material or combination thereof that would provide the functionality herein disclosed are contemplated as being within the scope of the present invention.

Finally, at least some embodiments of ion processing element 300 may be effective in facilitating the processing of a fluid stream by filtration, as well as by ion processing. For instance, the fibrous nature of substrate 302 may provide effective removal, by mechanical filtration, of one or more components of a fluid stream passing through ion processing element 300. Thus, embodiments of ion processing element 300 may incorporate both filtration and ion processing functionalities.

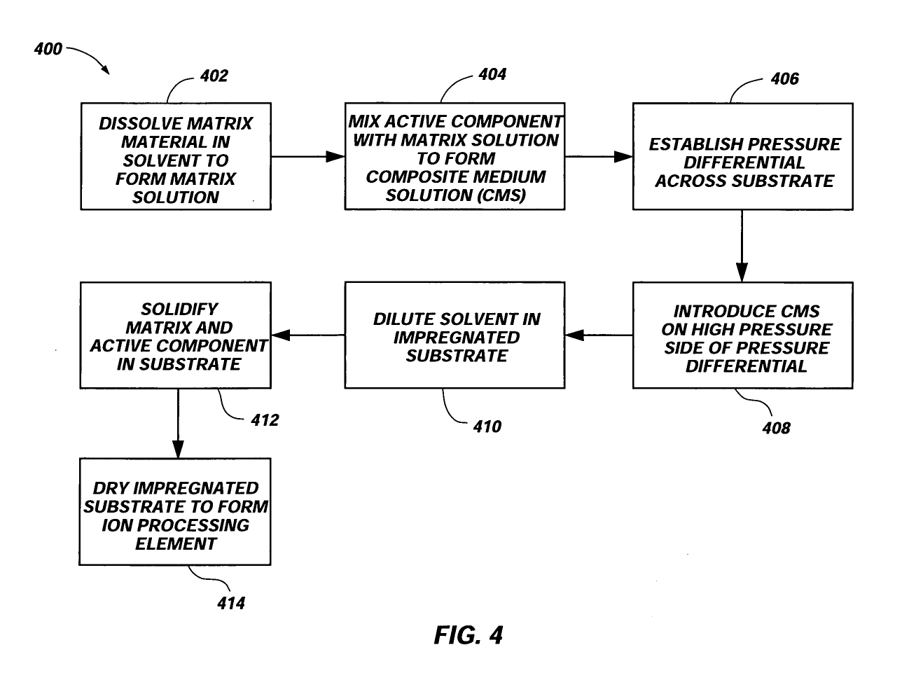

Directing attention now to FIG. 4, one embodiment of a process 400 for producing composite medium 304 is indicated. In step 402, a matrix material, such as PAN in a solid form, is dissolved in a solvent to form a matrix solution. The concentration of PAN with respect to the solvent may be varied as required to facilitate achievement of a particular desired result. For instance, the PAN may be present in the matrix solution from approximately 2 wt % to approximately 5 wt %. In one embodiment, the solvent comprises nitric acid (HNO₃). Other suitable solvents may include, but are not limited to, aprotic polar organic solvents such as dimethylformamide, dimethylacetamide, dimethylsulfoxide (DMSO), sulfolane, ethylene carbonate, and N-methylpyrrolidone; acids, such as concentrated sulfuric acid; and concentrated aqueous solutions of certain inorganic salts, such as lithium bromide, sodium thiocyanate, and zinc chloride. In general however, any solvent providing the functionality disclosed herein is contemplated as being within the scope of the present invention.

The matrix solution may be formed at room temperature (defined herein to be a range from about 50° F. to about 80° F.) and standard pressure (1.0 atmospheres or 14.65 pounds per square inch), though it will be appreciated that other temperatures and/or pressures may be equally desirable for various applications or to achieve particular results.

Upon dissolution of the PAN in the solvent, process 400 then proceeds to step 404. In step 404, a pre-determined amount of one or more active components may be combined with the matrix solution to form a composite medium solution (CMS). As used herein, the term “CMS” refers to any combination of solvent, matrix material, and active components, whether such combination takes the form of a suspension, emulsion, solution, or other form. For instance, when organic active component(s) are employed, the CMS may be an emulsion while, on the other hand, when inorganic active component(s) are employed, the CMS may be a suspension. Regardless of whether a suspension, emulsion, or solution is formed, the CMS may be homogenous. Alternatively, the CMS may be formed in-situ by precipitation or other processes. In at least some embodiments of the invention, the active component is Aliquat 336. However, it is understood that a variety of active components, both organic and inorganic, may be employed singly or in various combinations to form the CMS and, ultimately, a composite medium 304 and ion processing element 300 having particular desired properties. It will further be appreciated that the amount of active component(s) mixed with the matrix solution may be varied as required to achieve formation of a composite medium 304 having particular desired properties and capabilities.

After the CMS has been formed, process 400 proceeds to step 406. In step 406, a pressure differential may be established across substrate 302. In one embodiment of method 400, the pressure differential is established by subjecting one side of substrate 302 to a vacuum. In step 408, the CMS may be introduced on the high pressure side of the pressure differential. The pressure differential may cause the CMS to flow into, and substantially impregnate, substrate 302. In step 410, the CMS impregnated substrate 302 may be immersed in a water bath so that the solvent is diluted, removed, or otherwise neutralized. The temperature of the water bath may be varied as required to achieve a particular result or effect. Likewise, other aqueous solutions may be substituted for water to facilitate achievement of a desired result.

Upon dilution, removal, or neutralization of the solvent, composite medium 304 solidifies, as indicated in step 412 of process 400, and matrix material 304A entraps active component. The dilution of the solvent may desirably cause the composite medium 304 to solidify in the substrate 302. For instance, the matrix material 304A may solidify, forming a filter disk or filter medium including the matrix material 304A and the active component. In other words, the active component may be solidified in the matrix material 304A, in contrast to conventional ion processing elements that have a liquid form of the active component absorbed into pores of a polymer. Since the matrix material 304A and the active component form a homogenous CMS, the active component may be homogenously dispersed throughout the composite medium 304 after the solvent is removed. The active component may also be trapped by the matrix material 304A and remain in the pores 304B or in the small micropores of the matrix material 304A. In step 414, substrate 302 may be dried to form ion processing element 300. The substrate 302 may be dried by flowing air over the substrate 302. The air drying process lends mechanical strength and durability to the composite medium 304 disposed in substrate 302, which may provide the ion processing element 300 with the ability to withstand rough handling and other adverse environmental conditions. After drying, ion processing element 300 may be used.

It is also contemplated that the solvent may be reconstituted from the water bath by heating the water bath until the water evaporates and only the solvent remains. In this way, the solvent can be reused for multiple processes. Various other techniques may alternatively be employed to facilitate reconstitution of the solvent.

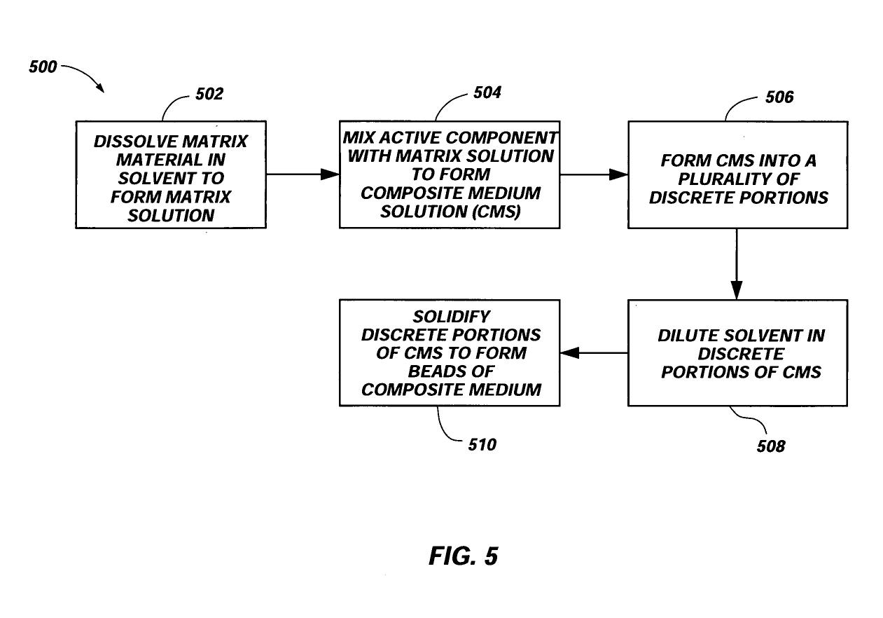

Alternatively, process 500, as indicated in FIG. 5, may be used to form the composite medium 304 into a solid phase extractant, such as beads. As used herein, the term “bead” refers to a discrete portion of composite medium 304 that has been substantially cleansed of solvent and includes the matrix material 304A that supports (i.e., contain, entraps, is bonded to, or otherwise includes or is attached to in any way) one or more active components. As shown in steps 502 and 504, the matrix solution and the CMS may be formed as described above in reference to FIG. 4. After the CMS is formed, the CMS may be formed into a plurality of discrete portions as shown in step 506. For instance, each discrete portion may comprise a discrete droplet of the CMS. However, the discrete portions may alternatively comprise any other geometry and/or volume necessary to suit the requirements of a particular application. The solvent in the droplets may be diluted, removed, or otherwise neutralized so that each droplet includes PAN and one or more active components, as shown in step 508. The solvent may be diluted by depositing the droplets into a water bath or the like. It will be appreciated that variables such as the temperature of the water bath may be varied as required to achieve a particular result or effect. Likewise, other aqueous solutions may be substituted for water to facilitate achievement of a desired result.

As shown in step 510, upon dilution, removal, or neutralization of the solvent, the PAN may solidify to form spherical particles within which the active component is homogenously dispersed. These beads may include the matrix material 304A, which has entrapped the active component(s) in a porous support. The droplets may then be dried, such as in air, to form beads of the composite medium 304. The air drying process may provide mechanical strength and durability to the beads, which provides the beads with the ability to withstand rough handling and other adverse environmental conditions. Once formed, the beads may be sieved, or otherwise sorted, to provide a desired size fraction necessary for a particular application. As an alternative to drying, beads 302 may be allowed to remain wet after the solvent has been diluted or removed, and used in that state.

As previously described, the solvent may be reconstituted from the water bath by heating the water bath until the water evaporates and only solvent remains. In this way, the solvent may be reused for multiple processes. A variety of other techniques may alternatively be employed to facilitate reconstitution of the solvent.

In one embodiment, the composite medium 304 may include PAN as the matrix material 304A and Aliquat 336 as the active component. The composite medium 304 may be produced into the ion processing element 300 or into the solid extractant, such as beads. To prepare the composite medium 304, a desired amount of PAN, in solid form, may be dissolved at room temperature and ambient pressure in the solvent, such as in HNO₃ or DMSO. After dissolving the PAN, the Aliquat 336 may be mixed into the matrix solution to form the CMS. The amount of PAN in the CMS may range from approximately 2% by weight to approximately 5% by weight. In this situation, the CMS is also referred to as the Aliquat 336/PAN mixture. The Aliquat 336 may be added to the matrix solution without dilution.

The Aliquat 336/PAN mixture may be mixed to uniformly disperse the Aliquat 336 within the matrix solution. The Aliquat 336/PAN mixture may be passed into the substrate 302, impregnating the substrate 302. For instance, the Aliquat 336/PAN mixture may be partially gravity filtered and/or vacuum filtered through the substrate 302 using a vacuum device, such as a filter apparatus, as known in the art. The substrate 302 impregnated with the Aliquat 336/PAN mixture may be immersed in the water bath to dilute, remove, or otherwise neutralize the solvent, forming a filter disk impregnated with the Aliquat 336/PAN mixture. Alternatively, the composite medium 304 may be produced in the form of beads, as previously described. For instance, the Aliquat 336/PAN mixture may be formed into discrete droplets that are immersed in a water bath to dilute the solvent.

Upon dilution, the Aliquat 336/PAN mixture may be solidified into a porous solid, entrapping the active component in a porous support within the composite medium 304. The porous solid may include from about 5 wt % to about 30 wt % Aliquat 336 and from about 70 wt % to about 95 wt % PAN. The solidified PAN impregnated filter disks or granular beads may be dried to increase mechanical strength. After drying, the ion processing element 300 or beads may be used in its desired application.

It is understood that the relative amounts of PAN and Aliquat 336 may be varied to achieve a desired loading of active component in the composite medium 304. For instance, the ratio of Aliquat 336 to PAN may be increased to improve the loading capabilities of the ion processing element 300. Desirably, a high loading of the active component in the composite medium 304 is achieved. For instance, the loading of the active component may range from about 5% by weight to about 30% by weight, such as from about 15% by weight to about 25% by weight.

The ion processing element 300 of the present invention may be used in a variety of fields. As suggested above, one use may be in off-site sampling. In particular, ion processing element 300 may be constructed of a size and/or geometry selected to make it readily portable. Ion processing element 300 may be transported or carried to a sampling site and the desired fluid stream or fluid sample passed through ion processing element 300 so that various desired constituents of the fluid stream may be concentrated in ion processing element 300 by composite medium 304.

The separated and concentrated constituents may correspond to the active component(s) employed in ion processing element 300. Once processing of the sample is completed, ion processing element 300 may be easily returned to a laboratory or processing site for analysis. In this way, transportation and time/cost-intensive analysis of large samples may be precluded and the entire sampling and analysis process greatly simplified.

A variety of analyses may be performed on the ion processing element 300 after processing of the sample has been completed. Such analyses may include, for example, radiometric spectrometry. As another example, a gas flow proportional counter or a gamma spectrometer may be used to quantify the concentration of one or more of the materials deposited in the ion processing element 300. Such analyses may provide a relative reduction in both the time and cost associated with some known analytical procedures.

Finally, ion processing element 300 may be cleaned for future re-use. For example, an ion processing element 300 containing plutonium removed from a fluid stream could be cleaned with oxalic acid or the like, so that the plutonium is substantially removed. Ion processing element 300 could then be reused as desired.

The ion processing element 300 may be used in high volume applications that require the effective and efficient removal, or other processing, of actinides such as uranium (U), plutonium (Pu), and americium (Am); lanthanides such as europium (Eu) and cerium (Ce); alkali metals such as cesium (Cs); alkaline earth metals such as strontium (Sr); transition metals such as technetium (Tc); organic contaminants; and chlorine. For instance, the ion processing element 300 may be used to selectively remove Pu over Am in acidic samples or solutions. Alternatively, the ion processing element 300 may be used to remove Tc from neutral or slightly acidic solutions. However, it is understood that embodiments of the invention may be effective in any application where efficient and effective ion processing of high volume flows is required.

In operation, the fluid stream passes through the ion processing element 300 and the composite media 304 disposed therein may remove one or more constituents of the fluid stream. Since the substrate 302 and the matrix material 304A are porous, they may possess a large pore volume which, as previously discussed, translates to a large surface area for ion processing. Thus, the active component dispersed throughout the matrix may possess a high ion processing capacity with respect to the fluid stream in contact therewith.

In one embodiment, an acidic fluid stream having a plurality of constituents, including Am and Pu, may be passed through the ion processing element 300 having Aliquat 336 as the active component and PAN as the matrix material 304A. The acidic fluid stream may have a pH from approximately 0 to approximately 3. Desirably, the acidic fluid stream has a pH from approximately 1 to approximately 3. The active component may selectively remove the Pu from the fluid stream, leaving the Am in the fluid stream. By removing the Pu, the fluid stream may be more easily disposed of. While both Pu and Am are transuranic (TRU) waste compounds, TRU activity in waste streams comes predominantly from Pu, with lesser activity coming from Am. Therefore, by separating the Pu from the Am, waste treatment of the fluid stream may be simplified.

In another embodiment, an alkaline, neutral, or acidic fluid stream having Tc as one of its constituents may be passed through the ion processing element 300 having Aliquat 336 as the active component and PAN as the matrix material 304A. The alkaline, neutral, or acidic fluid stream may have a pH ranging from approximately 1 to approximately 9. The active component may remove the Tc from the fluid stream.

Another desirable consequence of the porosity of the substrate 302 is that the substrate 302 may provide relatively little resistance to flow through the ion processing element 300 and, thus, the kinetic properties of the ion processing element 300 are favorable. That is, the porosity of the substrate 302 in which the composite media 304 are deposited may facilitate accommodation of a high volume fluid stream without imposing a material drop in pressure of the fluid stream that would otherwise compromise processing rates. In addition, the sorption capacity of the composite medium 304 may be increased since the active component is homogenously dispersed throughout the composite medium 304. Further, since the ion processing element 300 may be a small filter disk, the ion processing element 300 may be readily portable, making it well-suited for use in off-site processing of fluids. Finally, since the matrix material 304A is relatively durable, the ion process element 300 is well suited to withstand the rough handling and environmental conditions typically encountered in industrial applications and other uses.

### EXAMPLES

### Example 1

### Preparation of Filter Disks Including Aliquat 336 and PAN

3.1 grams of PAN was dissolved at room temperature in 67.5 ml of 15.8 M nitric acid with 7.5 ml water. Upon complete dissolution of the PAN, 0.62 g of Aliquat 336 was added to the solution with mixing to form a suspension. The suspension was vacuum filtered through a 47-mm Gelman® A/E glass fiber filter disk. When the suspension exited the bottom of the glass filter, the vacuum was released and the glass filter, impregnated with Aliquat 336 and PAN, was placed in the water bath to solidify the Aliquat 336 and PAN. The filter disks were dried and sized before use.

### Example 2

### Batch Equilibrium Testing of Fluid Samples Including Plutonium and Americium Using Aliquat 336/PAN Filter Disks

A filter disk impregnated with Aliquat 336/PAN, prepared as described in Example 1, was placed in a laboratory filter holder apparatus. Ten ml of 2M nitric acid were passed through the filter disk to condition the filter disk. Fifty ml of a groundwater sample that contained 5776 counts per minute (“cpm”) of Tc-99 per mL of water and had a pH of approximately 8 were passed through the filter disk. Ten ml of 2M nitric acid were then passed through the filter disk to rinse the water from the filter disk and laboratory filter holder apparatus. The water solution that passed through the filter disk was sampled and found to contain 0.5 cpm Tc-99 per mL, indicating that the Tc-99 was quantitatively removed from the water. The nitric acid rinse contained 1550 cpm Tc-99 per mL, indicating that it is possible to elute the Tc-99 from the disk. The Aliquat 336/PAN filter disk was counted directly (after rinsing and drying) and contained 50114 cpm Tc-99. While this measurement was not quantitative, it indicated that the filter disk contained a significant amount of Tc-99.

### Example 3

### Preparation of Beads Including Aliquat 336 and PAN

6.2 grams of PAN was dissolved into 135 ml of 15.8 M nitric acid mixed with 15 ml deionized water. Once the PAN was dissolved, 0.93 grams of Aliquat 336 was added to the mixture. Aliquat 336/PAN beads were formed by dropping the Aliquat 336/PAN mixture into a water bath with mixing to dilute the solvent. Upon dilution, the Aliquat 336/PAN mixture was solidified into a porous solid, entrapping the active component in a porous support within the filter disk. The beads were dried before use.

### Example 4

### Batch Equilibrium Testing of Fluid Samples Including Plutonium and Americium Using Aliquat 336/PAN Beads

0.015 g of the Aliquat 336/PAN beads described in Example 3 were added to 15 ml of each of 0.01M and 1.0M nitric acid solutions containing Pu-239 or Am-241 and mixed for 24 hours. The Pu and Am were present in the nitric acid solutions in minute, or tracer, quantities and had activities ranging from approximately 100 disintegrations per second to approximately 10,000 disintegrations per second. Distribution coefficients (K_{D}) for the samples were calculated by the following formula:

([ion]ᵢₙᵢₜᵢₐₗ−[ion]_{after contact}/[ion]_{after contact})×volume (mL) of liquid/mass in grams

as known in the art, where the ion is Pu or Am and the [ion]_{after contact} means the concentration of the ion in the liquid phase after contact with the composite medium 304 or the ion processing element 300. K_{D} values are provided in Table 1. A higher distribution coefficient indicates a higher removal efficiency for the ion.

TABLE 1
Distribution Coefficients for Pu and Am Samples

| Sample | Distribution Coefficient |
|---|---|
| Pu in 0.01 M acid | 3252 |
| Pu in 1.0 M acid | 5560 |
| Am in 0.01 M acid | 0 |
| Am in 1.0 M acid | 0 |

As shown in Table 1, the distribution coefficients for the Pu were significantly higher than those for the Am, indicating that the Aliquat 336/PAN beads effectively removed and separated the tetravalent Pu from the trivalent Am. In other words, the Aliquat 336/PAN material effectively removed and separated Pu from acidic solutions without removing the Am.

### Example 5

### Batch Equilibrium Testing of Fluid Samples Including Technetium Using Aliquat 336/PAN Beads

Technetium-99 tracer was added to two groundwater samples at approximately 1000 disintegrations per second. One groundwater sample had a pH of 2 and the other groundwater sample had a pH of 7. 0.015 g of the Aliquat 336/PAN beads described in Example 3 were added to 15 ml of each of the two samples. The Aliquat 336/PAN beads were mixed with the solutions for 24 hours. The distribution coefficients (K_{D}) for the samples were calculated as previously described, except that the ion is Tc, and are reported in Table 2.

TABLE 2
Distribution Coefficients for Tc Samples.

| Sample | K_{D} |
|---|---|
| Tc in a pH 2 solution | 45444 |
| Tc in a pH 7 solution | 942194 |

As shown in Table 2, the Aliquat 336/PAN beads effectively removed Tc from neutral or slightly acidic solutions. However, the Aliquat 336/PAN beads were less effective at removing Tc from acidic solutions.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A composite medium, comprising:
at least one trialkyl methylammonium compound homogenously dispersed in a polyacrylonitrile matrix.

2. The composite medium of claim 1, wherein the at least one trialkyl methylammonium compound comprises at least one of trialkyl methylammonium nitrate or trialkyl methylammonium chloride.

3. The composite medium of claim 1, wherein the at least one trialkyl methylammonium compound is present from approximately 5% by weight to approximately 30% by weight.

4. The composite medium of claim 1, wherein the polyacrylonitrile of the matrix is present from approximately 70% by weight to approximately 95% by weight.

5. The composite medium of claim 1, wherein the at least one trialkyl methylammonium compound homogenously dispersed in the polyacrylonitrile matrix comprises homogenous, substantially spherical particles.

6. The composite medium of claim 1, further comprising a substrate at least partially impregnated with the at least one trialkyl methylammonium compound homogenously dispersed in the polyacrylonitrile matrix.

7. The composite medium of claim 6, wherein the substrate comprises glass fiber, paper, or polytetrafluoroethylene.

8. A method of forming a composite medium, comprising:
dissolving polyacrylonitrile in a solvent to form a matrix solution;
combining at least one trialkyl methylammonium compound with the matrix solution to form a homogenous, composite medium solution;
diluting the solvent; and
solidifying the homogenous, composite medium solution.

9. The method of claim 8, wherein dissolving polyacrylonitrile in a solvent to form a matrix solution comprises dissolving from approximately 2% by weight to approximately 5% by weight polyacrylonitrile in the solvent.

10. The method of claim 8, wherein combining at least one trialkyl methylammonium compound with the matrix solution to form a homogenous, composite medium solution comprises combining at least one of trialkyl methylammonium nitrate or trialkyl methylammonium chloride in the matrix solution.

11. The method of claim 8, wherein combining at least one trialkyl methylammonium compound with the matrix solution to form a homogenous, composite medium solution comprises combining from approximately 5% by weight to approximately 30% by weight of the trialkyl methylammonium compound in the matrix solution.

12. The method of claim 8, wherein diluting the solvent comprises depositing portions of the composite medium solution into a water bath.

13. The method of claim 12, wherein solidifying the homogenous, composite medium solution comprises forming homogenous, substantially spherical beads from the portions of the composite medium solution.

14. The method of claim 8, further comprising impregnating the homogenous, composite medium solution into a substrate.

15. The method of claim 14, wherein impregnating the homogenous, composite medium solution into a substrate comprises impregnating the homogenous, composite medium solution into a glass fiber, paper, or polytetrafluoroethylene substrate.

16. The method of claim 14, wherein diluting the solvent comprises depositing the substrate into a water bath.

17. The method of claim 8, wherein solidifying the homogenous composite medium solution comprises entrapping the at least one at least one trialkyl methylammonium compound in the polyacrylonitrile.

18. A method of removing a constituent from a fluid stream, comprising:
providing a composite medium comprising at least one trialkyl methylammonium compound homogenously dispersed in a polyacrylonitrile matrix;
passing the fluid stream comprising the constituent through the composite medium; and
removing the constituent from the fluid stream.

19. The method of claim 18, wherein providing a composite medium comprising at least one trialkyl methylammonium compound homogenously dispersed in a polyacrylonitrile matrix comprises providing at least one of trialkyl methylammonium nitrate or trialkyl methylammonium chloride homogenously dispersed in the polyacrylonitrile matrix.

20. The method of claim 18, wherein providing a composite medium comprising at least one trialkyl methylammonium compound homogenously dispersed in a polyacrylonitrile matrix comprises providing the at least one trialkyl methylammonium compound from approximately 5% by weight to approximately 30% by weight.

21. The method of claim 18, wherein providing a composite medium comprising at least one trialkyl methylammonium compound homogenously dispersed in a polyacrylonitrile matrix comprises homogenously dispersing the at least one trialkyl methylammonium compound in from approximately 70% by weight to approximately 95% by weight polyacrylonitrile.

22. The method of claim 18, wherein passing the fluid stream comprising the constituent through the composite medium comprises passing the fluid stream comprising plutonium and americium through the composite medium.

23. The method of claim 18, wherein removing the constituent from the fluid stream comprises selectively removing the plutonium over the americium from the fluid stream.

24. The method of claim 18, wherein passing the fluid stream comprising the constituent through the composite medium comprises passing the fluid stream comprising technetium through the composite medium.

25. The method of claim 18, wherein removing the constituent from the fluid stream comprises removing the technetium from the fluid stream.
